(19) United States
(12) Patent Application Publication
(10) Pub. No.: US 2020/0379384 A1
(43) Pub. Date: Dec. 3, 2020

(54) HEATING DEVICE, FIXING DEVICE, AND IMAGE FORMING APPARATUS

(71) Applicants: Masahiro SAMEI, Kanagawa (JP); Tomoya ADACHI, Kanagawa (JP); Yukimichi SOMEYA, Saitama (JP); Yuusuke FURUICHI, Kanagawa (JP); Hiroshi SEO, Kanagawa (JP)

(72) Inventors: Masahiro SAMEI, Kanagawa (JP); Tomoya ADACHI, Kanagawa (JP); Yukimichi SOMEYA, Saitama (JP); Yuusuke FURUICHI, Kanagawa (JP); Hiroshi SEO, Kanagawa (JP)

(73) Assignee: Ricoh Company, Ltd., Tokyo (JP)

(21) Appl. No.: 16/829,083

(22) Filed: Mar. 25, 2020

(30) Foreign Application Priority Data
May 29, 2019 (JP) 2019-100253

(51) Int. Cl. G03G 15/20

(52) U.S. Cl. CPC G03G 15/2053; G03G 15/2039; G03G 2215/2003; G03G 15/2025; G03G 15/2064

(57) ABSTRACT

A heating device includes a sleeve-shaped flexible fixing rotator, a heater to contact an inner surface of the fixing rotator, a pressure rotator pressed against the heater via the fixing rotator to form a nip between the fixing rotator and the pressure rotator, a thermometer to detect a temperature of the heater, and a pressing force switching mechanism to switch a pressing force between the heater and the pressure rotator. The pressing force switching mechanism switches the pressing force between the heater and the pressure rotator in at least two stages, a standard force when the temperature of the heater detected by the thermometer increases and reaches a predetermined temperature and before the medium to be heated passes through the nip, and a reduced force smaller than the standard force when the temperature of the heater detected by the thermometer is lower than the predetermined temperature.

### CROSS-REFERENCE TO RELATED APPLICATION

This patent application is based on and claims priority pursuant to 35 U.S.C. § 119 to Japanese Patent Application No. 2019-100253, filed on May 29, 2019 in the Japan Patent Office, the entire disclosure of each of which is hereby incorporated by reference herein.

### BACKGROUND

### Technical Field

Embodiments of the present disclosure generally relate to a heating device, a fixing device, and an image forming apparatus. In particular, the embodiments of the present disclosure relate to a heating device, a fixing device with the heating device for fixing a toner image on a recording medium, and an image forming apparatus with the fixing device for forming an image on a recording medium.

### Background Art

Electrophotographic image forming apparatuses use various types of fixing devices. In one type of fixing device, a heater includes a heater substrate and a resistance heat generator (a planate heater) that heats a thin fixing belt having a low thermal capacity. The heater is positioned in a recess of a heater attachment portion formed in a heater holder.

In addition, the fixing device includes a pressure roller as a pressure rotator disposed outside the fixing belt, and the pressure roller is pressed against the heater via the fixing belt to form a fixing nip. A high heat conduction member is disposed between the heater and the recess of the heater attachment portion to reduce temperature unevenness in a longitudinal direction of the heater.

### SUMMARY

This specification describes an improved heating device that includes a sleeve-shaped flexible fixing rotator, a heater configured to contact an inner surface of the fixing rotator, a pressure rotator pressed against the heater via the fixing rotator to form a nip between the fixing rotator and the pressure rotator, a thermometer to detect a temperature of the heater, and a pressing force switching mechanism configured to switch a pressing force between the heater and the pressure rotator. A medium to be heated by the heater is conveyed through the nip. The pressing force switching mechanism switches the pressing force between the heater and the pressure rotator in at least two stages, a standard force when the temperature of the heater detected by the thermometer increases and reaches a predetermined temperature and before the medium to be heated passes through the nip, and a reduced force smaller than the standard force when the temperature of the heater detected by the thermometer is lower than the predetermined temperature.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic diagram illustrating a configuration of an image forming apparatus according to an embodiment of the present disclosure;

FIG. 2A is a schematic sectional view of a fixing device according to the embodiment incorporated in the image forming apparatus of FIGS. 1A and 1B;

FIG. 2B is a plan view of a heater;

FIG. 2C is a sectional view of the heater of FIG. 2B;

FIG. 2D is a schematic sectional view of the fixing device in a reduced force state;

FIG. 2E is a schematic sectional view of the fixing device in a standard force state;

FIG. 3 is a configuration diagram of control system of the heater;

FIG. 4 is a graph illustrating time-temperature curves of the heater;

FIG. 5 is a flowchart illustrating control of the heater and a pressure roller;

FIG. 6A is an explanatory diagram illustrating the fixing device in the standard force state;

FIG. 6B is an explanatory diagram illustrating the fixing device in the reduced force state;

FIG. 6C is an explanatory diagram illustrating the fixing device when the pressure roller rotates in the reduced force state;

FIG. 6D is an explanatory diagram illustrating the fixing device when the pressure roller rotates in the standard force state; and

FIG. 7 is an explanatory diagram illustrating changes of temperatures detected by a thermistor, a pressing force signal, a pressurizing drive signal, and a heater power in association with time.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Although the embodiments are described with technical limitations with reference to the attached drawings, such description is not intended to limit the scope of the disclosure and all of the components or elements described in the embodiments of this disclosure are not necessarily indispensable.

With reference to drawings, a description is given of an embodiment of a fixing device of an image forming apparatus that uses a heater according to the present disclosure and a laser printer as an example of the image forming apparatus using the fixing device. However, the image forming apparatus is not limited to the laser printer and may be a copier, a facsimile machine, a printer, a plotter, and a multifunction peripheral having at least two of copying, printing, facsimile transmission, plotting, and scanning capabilities; or an inkjet recording apparatus.

It is to be understood that identical or similar reference characters are given to identical or corresponding parts throughout the drawings, and redundant descriptions are omitted or simplified below. The dimensions, material, shape, and relative position in a description for each constituent component are examples. Unless otherwise specifically described, the scope of the present disclosure is not limited to those.

Although a “recording medium” is described as a “sheet” in the following embodiment, the “recording medium” is not limited to the sheet. Examples of the “recording medium” include not only the sheet but also an overhead projector (OHP) transparency, a fabric, a metallic sheet, a plastic film, and a prepreg sheet including carbon fibers previously impregnated with resin.

Examples of the “recording medium” include all mediums to which developer or ink can adhere, and so-called recording paper and recording sheets. Examples of the “sheet” include thick paper, a postcard, an envelope, thin paper, coated paper (e.g., coat paper and art paper), and tracing paper, in addition to plain paper.

The term “image formation” used in the following description means not only giving an image having a meaning, such as a character or a figure, to a medium but also giving an arbitrary image having no meaning, such as a pattern, to a medium.

A configuration of an image forming apparatus 100 including a fixing device 300 according to an embodiment of the present disclosure is described below.

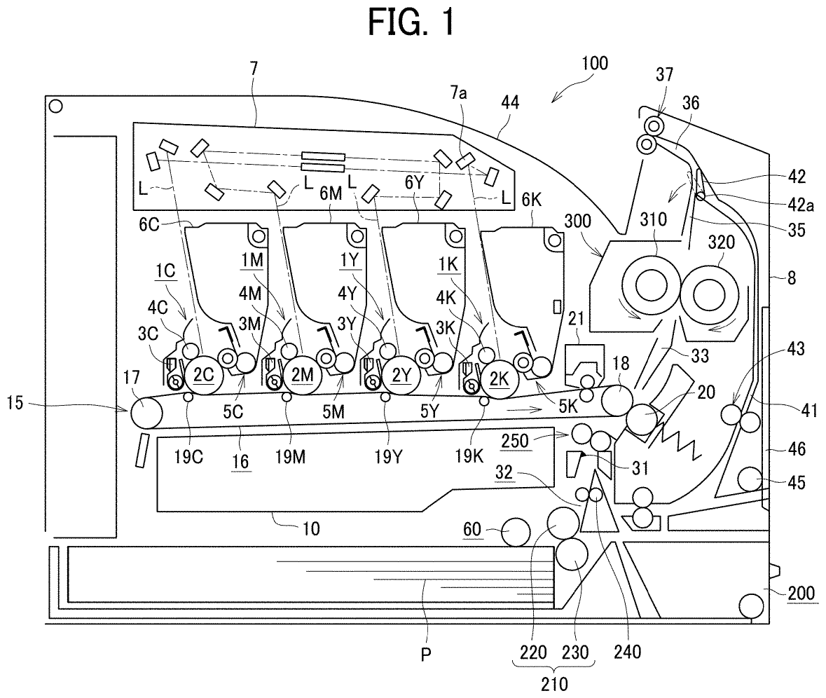

FIG. 1 is a schematic diagram illustrating a configuration of a color laser printer as an embodiment of the image forming apparatus 100.

The image forming apparatus 100 includes four processing units 1K, 1Y, 1M, and 1C each as an image forming device. Suffixes K, Y, M, and C are used to indicate respective colors of toner (that is, black, yellow, magenta, and cyan) for the processing units. The processing units each form an image with respective developers of black (K), yellow (Y), magenta (M), and cyan (C) in color corresponding to the color separation components of a color image.

The processing units 1K, 1Y, 1M, and 1C respectively include toner bottles 6K, 6Y, 6M, and 6C containing different color toners. Since the processing units 1K, 1Y, 1M, and 1C have a similar structure and differ only in the color of toner, the configuration of one processing unit 1K is described below as representative, and descriptions of the other processing units 1Y, 1M, and 1C are omitted.

The processing unit 1K includes an image bearer 2K such as a photoconductor drum, a photoconductor cleaner 3K, and a discharger. The processing unit 1K further includes a charging device 4K as a charger that uniformly charges the surface of the image bearer and a developing device 5K as a developing unit that renders visible an electrostatic latent image formed on the image bearer. The processing unit 1K is detachably attachable to a main body of the image forming apparatus 100. Consumable parts of the processing unit 1K can be replaced at one time.

An exposure device 7 is disposed above the processing units 1K, 1Y, 1M, and 1C in the image forming apparatus 100. The exposure device 7 performs writing and scanning based on image data, that is to say, irradiates the image bearer 2K with laser light L emitted by a laser diode and reflected by mirrors 7a based on the image data.

A transfer device 15 is disposed below the processing units 1K, 1Y, 1M, and 1C in the present embodiment. Primary transfer rollers 19K, 19Y, 19M, and 19C are disposed opposite the image bearers 2K, 2Y, 2M, and 2C, respectively, to contact an intermediate transfer belt 16.

The intermediate transfer belt 16 is entrained around the primary transfer rollers 19K, 19Y, 19M, and 19C, a drive roller 18, and a driven roller 17 and rotates. A secondary transfer roller 20 is disposed opposite the drive roller 18 to contact the intermediate transfer belt 16. It is to be noted that, when the image bearers 2K, 2Y, 2M, and 2C are called primary image bearers, the intermediate transfer belt 16 is called a secondary image bearer to bear a synthesized image made from images formed on the respective image bearers 2K, 2Y, 2M, and 2C.

A belt cleaner 21 is disposed downstream from the secondary transfer roller 20 in a direction of rotation of the intermediate transfer belt 16. A cleaning backup roller is disposed opposite the belt cleaner 21 via the intermediate transfer belt 16.

A sheet feeder 200 including a tray loaded with sheets P is disposed below the image forming apparatus 100. The sheet feeder 200 is configured as a recording-medium supply device and can house a sheaf of a large number of recording media sheets P. The sheet feeder 200 is configured as one unit together with a sheet feed roller 60 and a roller pair 210 as a conveyor for the sheets P.

The sheet feeder 200 is detachably inserted in the main body of the image forming apparatus 100 to supply the sheet. The sheet feed roller 60 and the roller pair 210 are disposed at upper portion of the sheet feeder 200 and convey the uppermost sheet P in the sheet feeder 200 to a sheet feeding path 32.

A registration roller pair 250 as a separation conveyor is disposed upstream from the secondary transfer roller 20 in a sheet conveyance direction and can temporarily stop the sheet P fed from the sheet feeder 200. Temporarily stopping the sheet P causes slack on the leading-edge side of the sheet P and corrects a skew of the sheet P.

A registration sensor 31 is disposed immediately upstream from the registration roller pair 250 in the sheet conveyance direction and detects a passage of a leading edge of the sheet. When a predetermined period of time passes after the registration sensor 31 detects the passage of the leading edge of the sheet, the sheet contacts the registration roller pair 250 and temporarily stops.

Conveyance rollers 240 are disposed downstream from the sheet feeder 200 to convey the sheet conveyed on the right side from the roller pair 210 upward. As illustrated in FIG. 1, the conveyance rollers 240 conveys the sheet to the registration roller pair 250 upward.

The roller pair 210 includes a pair of an upper roller and a lower roller. The roller pair 210 can adopt a friction reverse roller (feed and reverse roller (FRR)) separation system or a friction roller (FR) separation system. In the FRR separation system, a separation roller (a return roller) is applied a certain amount of torque in the counter sheet feeding direction from a driving shaft via a torque limiter and pressed against a feed roller to separate a sheet with the nip between the rollers. In the FR separation system, a separation roller (friction roller) is supported by a secured shaft via a torque limiter and pressed against a feed roller to separate a sheet with the nip between the rollers.

The roller pair 210 in the present embodiment adopts the FRR separation system. That is, the roller pair 210 includes an upside feed roller 220 that conveys the sheet toward the image forming apparatus and a downside separation roller 230 that gives a driving force in a reverse direction of the upside feed roller 220 with a driving shaft through a torque limiter.

The separation roller 230 is pressed against the feed roller 220 by a pressing member such as a spring. A clutch transmits a driving force of the feed roller 220 to the feed roller 220, and the sheet feed roller 60 rotates left in FIG. 1.

The registration roller pair 250 sends the sheet P that contacts the registration roller pair 250 and has the slack on the leading-edge side of the sheet P toward the secondary transfer nip between the secondary transfer roller 20 and the drive roller 18 at a suitable timing to transfer the toner image on the intermediate transfer belt 16 onto the sheet P. A bias applied at the secondary transfer nip electrostatically transfers the toner image formed on the intermediate transfer belt 16 onto the sent sheet P at a desired transfer position with high accuracy.

A post-transfer conveyance path 33 is disposed above the secondary transfer nip between the secondary transfer roller 20 and the drive roller 18. The fixing device 300 is disposed near an upper end of the post-transfer conveyance path 33. The fixing device 300 includes a fixing belt 310 including a heater 340 and a pressure roller 320 as a pressure rotator that rotates while abutting on the fixing belt 310 at a predetermined pressure.

A post-fixing conveyance path 35 is disposed above the fixing device 300 and branches into a sheet ejection path 36 and a reverse conveyance path 41 at the upper end of the post-fixing conveyance path 35. At this branching portion, the switching member 42 is disposed and pivots on a pivot shaft 42a. At an opening end of the sheet ejection path 36, a pair of sheet ejection rollers 37 are disposed.

The reverse conveyance path 41 begins from the branching portion and converges into the sheet feeding path 32. Additionally, a reverse conveyance roller pair 43 is disposed midway in the reverse conveyance path 41. An upper face of the image forming apparatus 100 is recessed to an inner side of the image forming apparatus 100 and serves as an output tray 44.

A powder container 10 such as a toner container is disposed between the transfer device 15 and the sheet feeder 200. The powder container 10 is removably installed in the apparatus body of the image forming apparatus 100.

Suitable sheet conveyance in the image forming apparatus 100 according to the present embodiment needs a predetermined length from the sheet feed roller 60 to the secondary transfer roller 20. The powder container 10 is disposed in a dead space caused by that distance to keep the entire image forming apparatus compact.

A transfer cover 8 is disposed above the sheet feeder 200 and on a front side to which the sheet feeder 200 is pulled out. The transfer cover 8 can be opened to check an interior of the image forming apparatus 100. The transfer cover 8 includes a manual sheet feed roller 45 for manual sheet feeding and a manual sheet feeding tray 46 for the manual sheet feeding.

Referring to FIG. 1, operations of the image forming apparatus 100 according to the present embodiment are described below. Initially, single-side printing is described.

Referring to FIG. 1, the sheet feed roller 60 rotates in response to a sheet feeding signal from a controller of the image forming apparatus 100. The sheet feed roller 60 separates the uppermost sheet from a sheaf of sheets P loaded in the sheet feeder 200 and sends the uppermost sheet out to the sheet feeding path 32.

After the sheet feed roller 60 and the roller pair 210 send the sheet P, when the leading edge of the sheet P reaches a nip of the registration roller pair250, the sheet P forms the slack and temporarily stops. The registration roller pair 250 corrects the skew on the leading-edge side of the sheet P and rotates in synchronization with an optimum timing to transfer a toner image formed on the intermediate transfer belt 16 onto the sheet P.

When the sheet P is fed from the manual sheet feeding tray 46, the sheets P of the sheet bundle loaded on the manual sheet feeding tray 46 are fed one by one from the uppermost sheet placed on top of the sheet bundle by the manual sheet feed roller 45. Then, the sheet P passes part of the reverse conveyance path 41 to be conveyed to the nip of the registration roller pair 250. The subsequent operations are the same operations as the sheet feeding operations from the sheet feeder 200.

As to image formation, operations of the processing unit 1K is described as a representative, and the descriptions of the other processing units 1Y, 1M, and 1C are omitted. First, the charging device 4K uniformly charges the surface of the image bearer 2K to high potential. The exposure device 7 emits a laser light L onto the surface of the image bearer 2K according to image data.

The surface of the image bearer 2K irradiated with the laser light L has an electrostatic latent image due to a drop in the potential of the irradiated portion. The developing device 5K includes a developer bearer bearing a developer including toner and transfers unused black toner supplied from the toner bottle 6K to the surface portion of the image bearer 2K having the electrostatic latent image, through the developer bearer.

The image bearer 2K to which the toner has been transferred forms (develops) a black toner image on the surface of the image bearer 2K. The black toner image formed on the image bearer 2K is transferred onto the intermediate transfer belt 16.

The photoconductor cleaner 3K removes toner remaining on the surface of the image bearer 2K after the primary-transfer process. The removed residual toner is conveyed by a waste toner conveyance unit and collected to a waste toner container in the processing unit 1K. The discharger discharges the remaining charge on the image bearer 2K from which the remaining toner is removed by the photoconductor cleaner 3K.

Similarly, toner images are formed on the image bearers 2Y, 2M, and 2C in the processing units 1Y, 1M, and 1C for the colors, and color toner images are transferred to the intermediate transfer belt 16 such that the color toner images are superimposed on each other.

The intermediate transfer belt 16 to which the color toner images are transferred and superimposed reaches the secondary transfer nip between the secondary transfer roller 20 and the drive roller 18. The registration roller pair 250 rotates to nip the sheet P contacting the registration roller pair 250 at a predetermined timing and conveys the sheet P to the secondary transfer nip of the secondary transfer roller 20 at a suitable timing to transfer the transferred and superimposed toner image formed on the intermediate transfer belt 16 onto the sheet P. In this manner, the toner image on the intermediate transfer belt 16 is transferred to the sheet P sent out by the registration roller pair 250.

The sheet P having the transferred toner image is conveyed to the fixing device 300 through the post-transfer conveyance path 33. The sheet P conveyed to the fixing device 300 is sandwiched by the fixing belt 310 and the pressure roller 320. Then, heating and pressing fixes the unfixed toner image to the sheet P. The sheet P fixed the toner image is sent out from the fixing device 300 to the post-fixing conveyance path 35.

The switching member 42 opens the upper end of the post-fixing conveyance path 35, as indicated with the solid line of FIG. 1, when the fixing device 300 sends out the sheet P. The sheet P sent from the fixing device 300 is sent to the sheet ejection path 36 via the post-fixing conveyance path 35. The pair of sheet ejection rollers 37 nips the sheet P sent out to the sheet ejection path 36 and rotates to eject the sheet P to the output tray 44. Then, the single-sided printing finishes.

Next, duplex printing is described. Like the single-sided printing described above, the fixing device 300 sends out the sheet P to the sheet ejection path 36. In duplex printing, the pair of sheet ejection rollers 37 rotates to convey a part of the sheet P outside the image forming apparatus 100.

When the trailing edge of the sheet P passes through the sheet ejection path 36, the switching member 42 pivots on the pivot shaft 42a as indicated with a dotted line in FIG. 1 to close the upper end of the post-fixing conveyance path 35. When the upper end of the post-fixing conveyance path 35 is closed, nearly simultaneously, the pair of sheet ejection rollers 37 rotates in reverse to convey the sheet P to an inner side of the image forming apparatus 100, that is, to the reverse conveyance path 41.

The sheet P sent out to the reverse conveyance path 41 reaches the registration roller pair 250 via the reverse conveyance roller pair 43. The registration roller pair 250 sends out the sheet P to the secondary transfer nip at a suitable timing to transfer the toner image formed on the intermediate transfer belt 16 onto the other surface of the sheet P to which no toner image has been transferred.

When the sheet P passes through the secondary transfer nip, the secondary transfer roller 20 and the drive roller 18 transfer the toner image to the other surface of the sheet P to which no toner image has been transferred (back face). The sheet P having the transferred toner image is conveyed to the fixing device 300 through the post-transfer conveyance path 33.

In the fixing device 300, the sheet P is sandwiched by the fixing belt 310 and the pressure roller 320, and heat and pressure are applied to fix the unfixed toner image formed on the back face of the sheet P. The sheet P having the toner images fixed to both front and back faces of the sheet P in this manner is sent out from the fixing device 300 to the post-fixing conveyance path 35.

The switching member 42 opens the upper end of the post-fixing conveyance path 35, as indicated with the solid line of FIG. 1, when the fixing device 300 sends out the sheet P. The sheet P sent from the fixing device 300 is sent to the sheet ejection path 36 via the post-fixing conveyance path 35. The pair of sheet ejection rollers 37 nips the sheet P sent out to the sheet ejection path 36 and rotates to eject the sheet P to the output tray 44 to finish duplex printing.

After the toner image on the intermediate transfer belt 16 is transferred onto the sheet P, residual toner remains on the intermediate transfer belt 16. The belt cleaner 21 removes the residual toner from the intermediate transfer belt 16. The waste toner conveyance unit conveys the toner removed from the intermediate transfer belt 16 to the powder container 10, and the toner is collected inside the powder container 10.

Next, the fixing device 300 and the heater 340 are described below. The heater 340 is disposed inside a loop of the fixing belt 310 of the fixing device 300 to heat the fixing belt 310.

In a warm-up operation before the start of printing in the present disclosure, the pressing force from the heater 340 to the pressure roller 320 is set to be reduced, the pressure roller 320 starts rotating, and the heater 340 heats the fixing belt 310 at a lower temperature than a temperature during printing. After the temperature of the fixing belt 310 and the heater 340, that is, the temperature of lubricant interposed in the belt sliding contact portion, which is an inner nip, has reached a predetermined temperature T1, a pressing force of the pressure roller 320 is switched to the standard force that is the pressing force for printing, and the heater 340 is switched to normal heating. When the heater 340 reaches the predetermined temperature T2, the warm-up operation ends.

Since the pressure roller 320 presses against the heater 340 with the reduced force in the initial rotation of the pressure roller 320, a contact area between the fixing belt 310 and the heater 340 becomes small, which reduces the starting torque of the pressure roller 320. The small contact area between the fixing belt 310 and the heater 340 reduces the amount of heat that transfers to the pressure roller 320, which can shorten a warm-up time.

Since warming the lubricant in the inner nip to the predetermined temperature decreases the viscosity of the lubricant, the rotational torque of the pressure roller 320 decreases. Therefore, even after the pressing force from the heater 340 to the pressure roller 320 is switched to the standard force, the rotational torque of the pressure roller 320 does not increase.

Consequently, a downsized motor manufactured at reduced cost can be employed as the driving motor of the pressure roller 320. In addition, decrease in a load applied to the fixing belt 310 when the fixing belt 310 starts to rotate causes the fixing belt 310 to run smoothly, and the smooth running of the fixing belt 310 prevents breakage and wear of the end of the fixing belt 310, which can lengthen the life of the fixing belt 310.

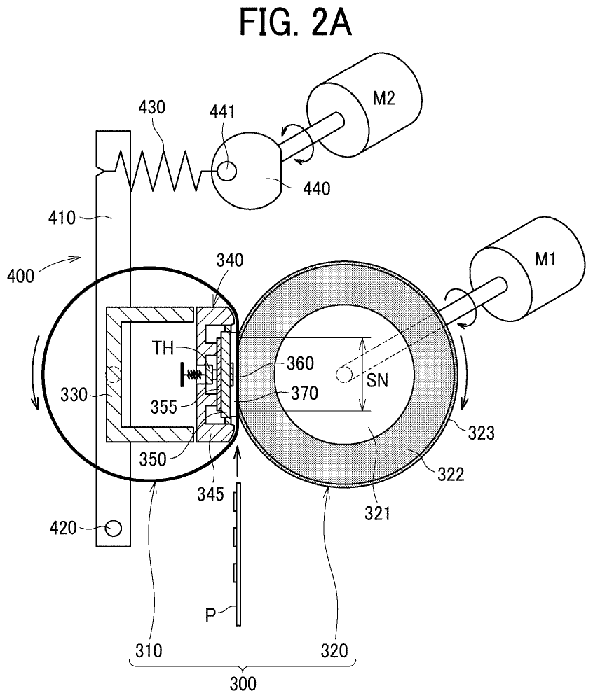

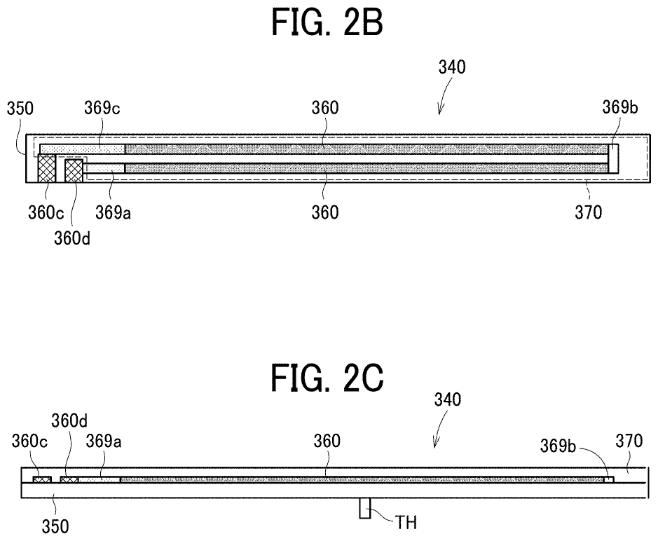

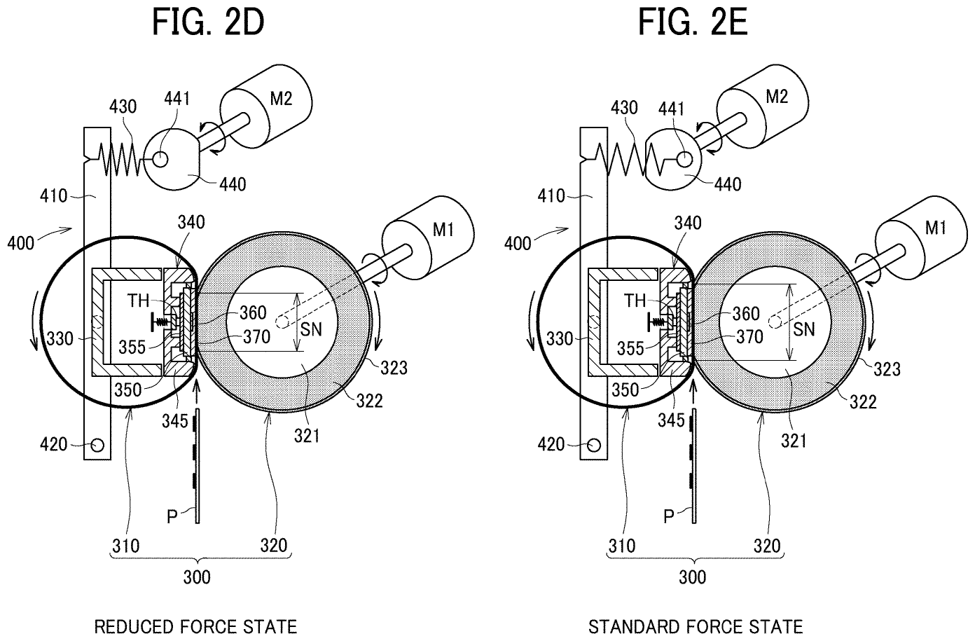

As illustrated in FIG. 2A, the fixing device 300 includes the pressure roller 320 and the thin fixing belt 310 having a low thermal capacity. The fixing belt 310 includes, for example, a tubular base made of polyimide (PI), the tubular base having an outer diameter of 25 mm and a thickness of from 40 to 80 μm.

The fixing belt 310 further includes a release layer as an outermost surface layer. The release layer is made of fluororesin, such as tetrafluoroethylene-perfluoroalkylvinylether copolymer (PFA) and polytetrafluoroethylene (PTFE), and has a thickness of from 5 μm to 20 μm to enhance durability of the fixing belt 310 and facilitate separation of the sheet P from the fixing belt 310. An elastic layer made of rubber having a thickness of from 50 to 200 μm may be provided between the base and the release layer.

The tubular base of the fixing belt 310 is not limited to polyimide, and thus may be made of heat-resistant resin, such as polyetheretherketone (PEEK), or a metal, such as nickel (Ni) or stainless steel (SUS). The inner circumferential surface of the fixing belt 310 may be coated with polyimide or polytetrafluoroethylene (PTFE) as a slide layer.

The pressure roller 320 having, for example, an outer diameter of 25 mm, includes a solid iron bar as a core 321, an elastic layer 322 on the surface of the core 321, and a release layer 323 formed on the outside of the elastic layer 322. The elastic layer 322 is made of silicone rubber and has, for example, a thickness of from 3.5 mm to 4.0 mm.

Preferably, the release layer 323 is formed by a fluororesin layer having, for example, a thickness of from 20 μm to 40 μm on the surface of the elastic layer 322 to improve releasability. A pressing force switching mechanism 400 presses the fixing belt 310 against the pressure roller 320.

A stay 330 and a holder 345 are disposed axially inside the loop of the fixing belt 310. The stay 330 is configured by a channeled metallic member, and both side plates located both ends of the heater 340 support the both end portions of the stay 330. The stay 330 reliably receives the pressing force of the pressure roller 320 to stably form the fixing nip SN as a nip.

The holder 345 holds a base 350 of the heater 340 and is supported by the stay 330. Preferably, the holder 345 is made of heat-resistant resin having low thermal conduction, such as a liquid crystal polymer (LCP). This reduces heat transfer from the heater to the holder 345 and enables efficient heating of the fixing belt 310.

The holder 345 has a shape that supports two portions of the base 350 near both end portions in a short side direction of the base 350 to avoid contact with a high-temperature portion of the base 350. This shape further reduces an amount of heat reaching the holder 345 and enables the fixing belt 310 to be heated efficiently. However, when it is desired to prevent a temperature rise on the surface of the heater 340 opposite to the sliding contact surface with the fixing belt 310, the contact area of the base 350 with the holder 345 may be increased to increase the amount of heat flowing to the holder 345.

Next, the heater 340 is described.

As illustrated in FIGS. 2B and 2C, the heater 340 includes a heat generation pattern 360 configured by a resistive heat generator. The heat generation pattern 360 is a thin, elongated metallic plate formed on the base 350 covered with an insulation layer 370.

A thermistor TH as a thermometer is attached to the back surface of the base 350 at the center in the longitudinal direction of the base 350. The thermistor TH detects the temperature of the heater 340.

The insulation layer 370 is formed to cover the heat generation pattern 360 and power supply lines 369a to 369c on the base 350. The power supply lines 369a to 369c are described below. The insulation layer 370 provides electrical insulation of the heat generation pattern 360 and the power supply lines 369a to 369c and slidability between the insulation layer 370 and the inner surface of the fixing belt 310. The heater 340 transfers heat to the inner surface of the fixing belt 310 which is in contact with the insulation layer 370 to heat the fixing belt 310 and increase the temperature of the fixing belt 310 and heats the unfixed toner image conveyed to the fixing nip SN to fix the unfixed image onto the sheet.

Low-cost aluminum or stainless steel is preferable as the material of the base 350. However, the material of the base 350 is not limited to metal and alternatively may be a ceramic, such as alumina or aluminum nitride, or a nonmetallic material having excellent thermal resistance and insulating properties, such as glass or mica. The heater 340 according to the present embodiment uses an alumina base having a lateral width of 8 mm, a longitudinal width of 270 mm, and a thickness of 1.0 mm.

Next, a high heat conduction member 355 is described.

As illustrated in FIG. 2A, the high heat conduction member 355 is attached to the back surface of the base 350 to uniform the heat in the heater 340 and improve the image quality. The high heat conduction member 355 may be made of a material having a high thermal conductivity such as copper, graphite, or graphene. The base 350 itself may be made of these materials having high thermal conductivity.

A shorter width of the high heat conduction member 355 is set to be shorter than a shorter width of the base 350 so that the base 350 completely covers the high heat conduction member 355. The above-described configuration can prevent an edge of the base 350 in the heater 340 from cutting into the high heat conduction member 355 even when repeated contact and slippage of the heater 340 and the fixing belt 310 causes displacement of the heater 340 and the fixing belt 310 in the short-side direction.

Next, the heat generation pattern 360 is described.

As illustrated in detail in FIGS. 2B and 2C, the heat generation pattern 360 is formed in two lines parallel to the longitudinal direction of the base 350 and connected in series. End portions in one direction of the two parallel lines of the heat generation pattern 360 on one end of the base 350 are coupled to electrodes 360c and 360d to supply power via power supply lines 369a and 369c respectively, and the power supply lines 369a and 369c have small resistance value and extend in the longitudinal direction from the one end portions of the heat generation pattern 360 on the base 350. The electrodes 360c and 360d are coupled to a power supply unit using an AC power supply (AC voltage 100 V).

End portions in the other direction of the two parallel lines of the heat generation pattern 360 on the other end of the base 350 are coupled to each other by a low-resistance power supply line 369b extending in the short side direction of the base 350 on the other end of the base 350. As a result, the heat generation pattern 360 has a form turned back in the longitudinal direction of the base 350. The heat generation pattern 360, the electrodes 360c and 360d, and the power supply lines 369a to 369c are formed with a predetermined line width and thickness by screen printing using silver (Ag) or silver palladium (AgPd).

The heat generation pattern 360 is made of a resistance material having a positive temperature coefficient of resistance. In the present embodiment, the temperature coefficient of resistance is 300 ppm. The resistance value of the heat generation pattern 360 may be, for example, 10Ω at normal temperature. In addition, a silver alloy (AgPt), ruthenium oxide (RuO₂), or the like may be used as a resistance material of the heat generation pattern 360.

The surfaces of the heat generation pattern 360 and the power supply lines 369a to 369c are covered with a thin overcoat layer or the insulation layer 370. The insulation layer 370 ensures good slidability between the heater 340 and the fixing belt 310 and the insulation between the fixing belt 310 and the heat generation pattern 360 and the power supply lines 369a to 369c.

A material of the insulation layer 370 may be, for example, a thermal resistance glass having a thickness of 75 μm. The heat generation pattern 360 transfers heat to the fixing belt 310 that contacts the insulation layer 370, raise the temperature of the fixing belt 310, and heats the unfixed toner image on the sheet P conveyed to the fixing nip SN to fix the toner image onto the sheet P.

Next, a controller 500 of the image forming apparatus 100 is described.

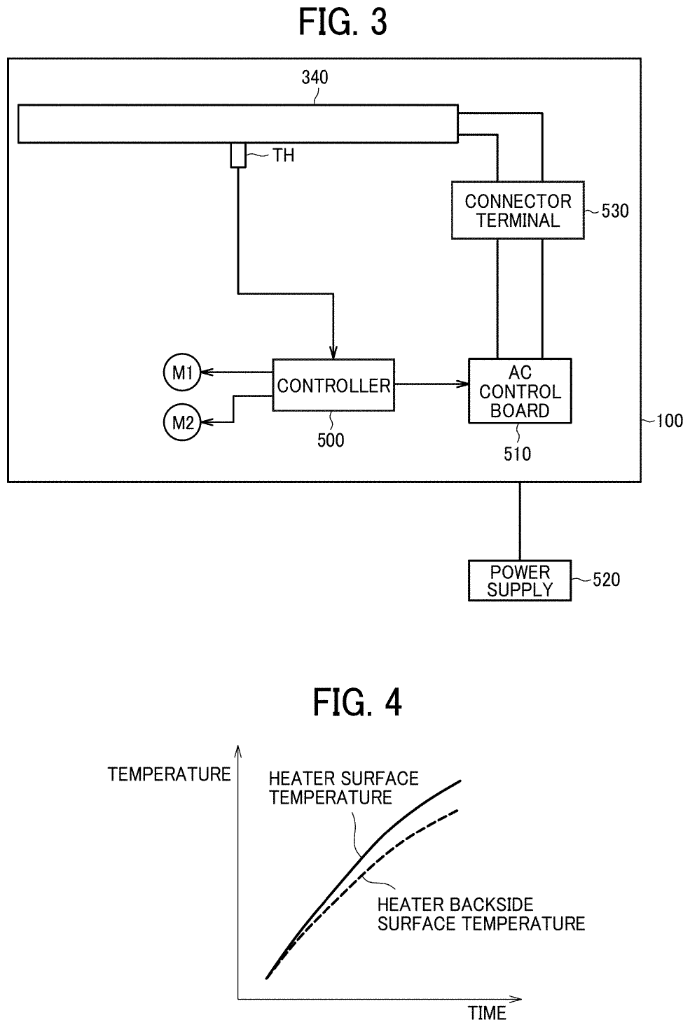

As illustrated in FIG. 3, the image forming apparatus 100 includes the controller 500 and an AC control board 510. The AC control board 510 adjusts an AC current from a power supply 520 coupled to the image forming apparatus 100 to a predetermined power and supplies the power to the heater 340 through the connector terminal 530. The controller 500 controls the AC control board 510 based on temperatures detected by the thermistor TH in the heater 340 and, as described below, controls a motor M1 to drive the pressure roller 320 and a switching motor M2 to drive the pressing force switching mechanism 400.

The controller 500 is configured by a microcomputer including a central processing unit (CPU), a read only memory (ROM), a random-access memory (RAM), an input and output interface, and the like. When the sheet P is conveyed through the fixing nip N, the controller 500 and the thermistor TH control the temperature of the fixing belt 310 to the desired temperature with an appropriate input of additional power in consideration of the heat removed by the sheet P conveyed through the fixing nip N, in addition to the temperature detected by the thermistor TH.

Next, the pressing force switching mechanism 400 is described.

As illustrated in FIG. 2A, a spring 430 of the pressing force switching mechanism 400 presses the heater 340 against the pressure roller 320. As a result, the heater 340 contacts the pressure roller 320 via the fixing belt 310 to form a fixing nip SN.

The pressing force switching mechanism 400 includes a pair of levers 410 that hold both ends of the stay 330 and a rotary plate 440 that is made a half turn in both the forward and reverse directions by the motor M2. A fulcrum pin 420 fixedly supports the lower end portion of each lever 410, and each lever 410 is configured to be able to swing left and right about the fulcrum pin 420.

The spring 430 is stretched between the upper end portion of the lever 410 and a pin 441 projecting from the rotary plate 440. The spring 430 pulls the upper end portion of the lever 410 and presses the heater 340 against the pressure roller 320.

As illustrated in FIG. 2D, when the motor M2 rotates and moves the pin 441 of the rotary plate 440 to the left side, the spring 430 is shortened. In this state, the heater 340 presses against the pressure roller 320 via the fixing belt 310 with the reduced force that is smaller than the standard force.

On the other hand, as illustrated in FIG. 2E, when the motor M2 rotates and moves the pin 441 of the rotary plate 440 to the right side, the spring 430 is lengthened. In this state, the heater 340 presses against the pressure roller 320 via the fixing belt 310 with the standard force that is larger than the reduced force.

Another lever may be provided to remove a jammed sheet and be configured to manually move the upper end portion of the lever 410 to the left side in FIGS. 2D and 2E and separate the heater 340 from the pressure roller 320.

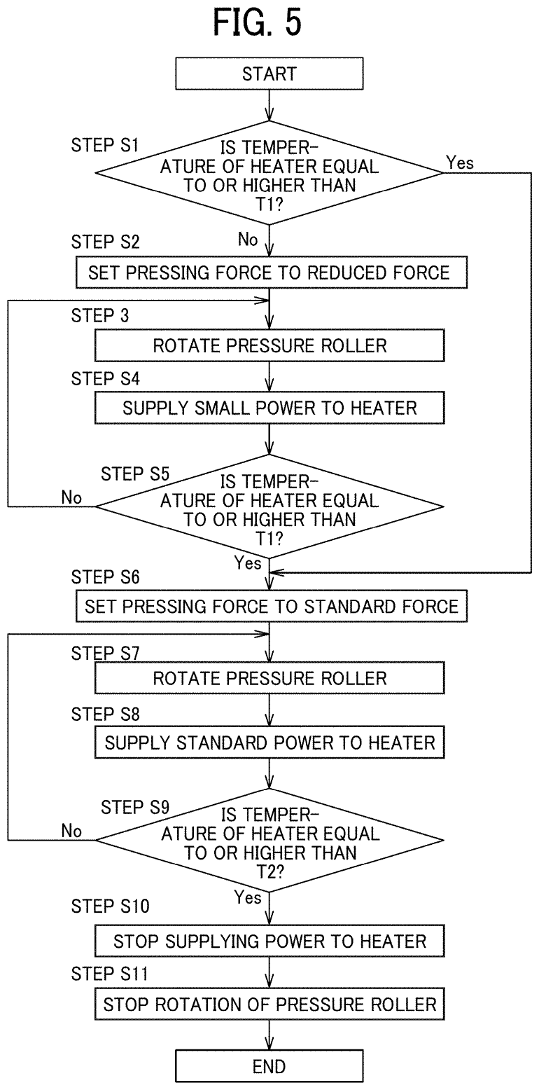

Next, with reference to a flowchart of FIG. 5, the warm-up operation of the heater 340, that is, a pressing and heating operation of the heater 340 before starting printing is described.

In step S1 of the flowchart of FIG. 5, the thermistor TH of the heater 340 detects the temperature of the heater 340. The controller 500 in FIG. 3 determines whether the temperature detected by the thermistor TH is equal to or higher than the predetermined temperature T1. The predetermined temperature T1 is set according to the softening point temperature of the lubricant.

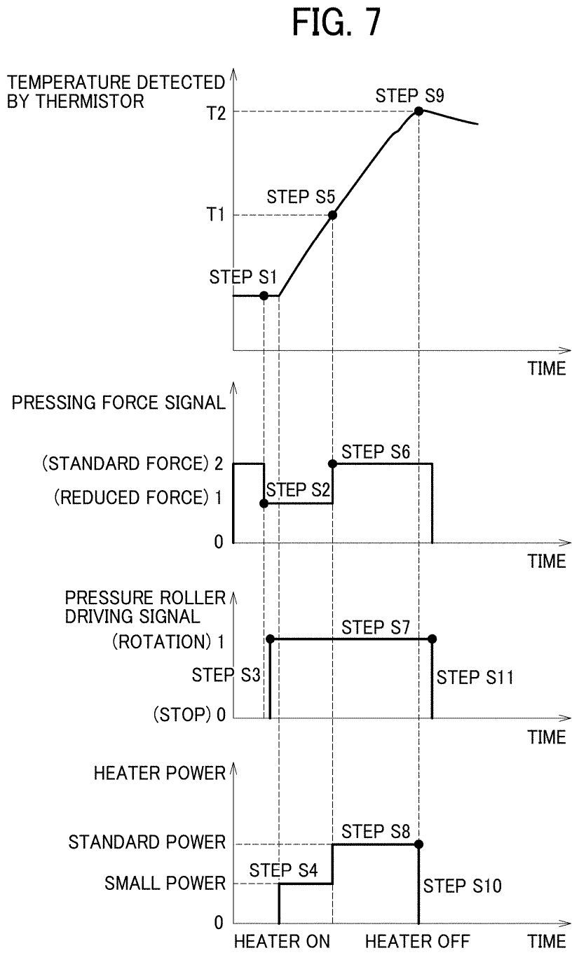

When the temperature detected by the thermistor TH is equal to or higher than the predetermined temperature T1, the process moves to step S6 described below, and the controller 500 sets the pressing force of the heater 340 to the standard force. When the temperature detected by the thermistor TH is lower than the predetermined temperature T1 (No in step S1) (see a graph of temperature detected by the thermistor in FIG. 7), the controller 500 sets the pressing force of the heater 340 to the reduced force in step S2 (see a graph of pressing force signal in FIG. 7).

The pressing force of the heater 340 is set based on the temperature of the lubricant in the inner nip which affects the viscosity of the lubricant, but the temperature of the lubricant cannot be directly measured. However, heater surface temperatures that are the temperatures of the lubricant have a certain correlation with heater backside surface temperatures.

FIG. 4 is a graph illustrating time-temperature curves, one relating the heater surface temperatures that are the temperatures of the lubricant and the other relating the heater backside surface temperatures. Examining the curves in advance enables accurate estimation of the heater surface temperatures that are the temperatures of the lubricant based on the heater backside surface temperatures. In the present embodiment, the estimated heater surface temperatures as described above are defined as the temperatures of the lubricant.

Since the pressing force of the heater 340 is set to be the reduced force that is smaller than the standard force, the fixing nip SN in FIG. 2D has a short length in the sheet conveyance direction. On the other hand, the fixing nip SN in FIG. 2E has a longer length in the sheet conveyance direction than the fixing nip SN in FIG. 2D because the pressing force of the heater 340 is set to be the standard force.

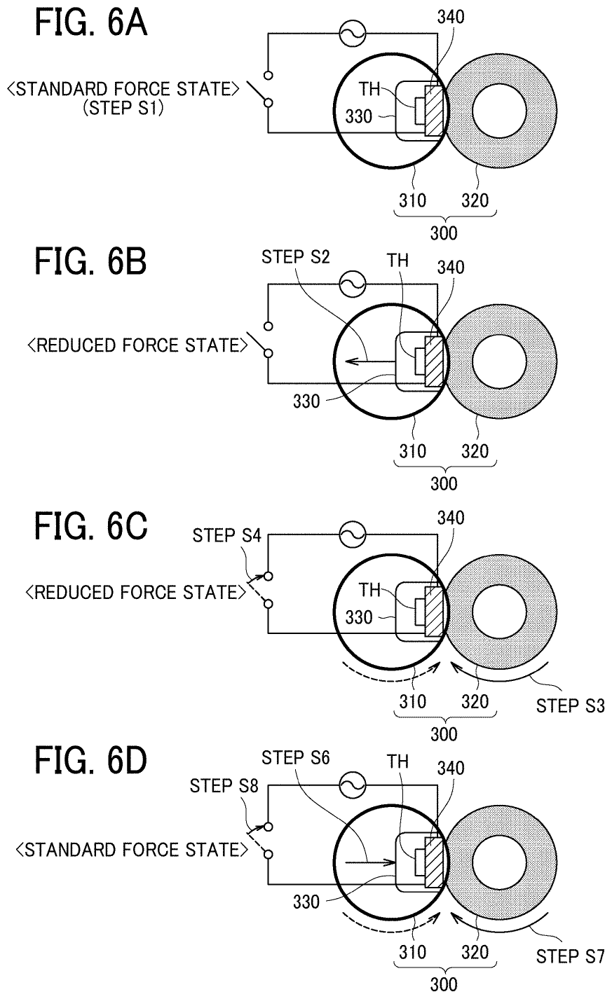

When the temperature detected by the thermistor TH is lower than the predetermined temperature T1, the controller 500 sets the reduced force state in which the pressing force of the heater 340 is smaller than the standard force in step S2. The controller 500 controls the pressing force switching mechanism 400 to switch the pressing force as illustrated in FIG. 2D and set the reduced force state. As illustrated in FIGS. 6A and 6B, when the controller 500 switches the pressing force switching mechanism 400 from the standard force state to the reduced force state, the fixing belt 310 and the heater 340 move away from the pressure roller 320.

Next, in step S3, the controller 500 controls the motor M1 to start rotation of the pressure roller 320 (see a graph of a pressure roller driving signal in FIG. 7). As a result, the fixing belt 310 is driven and rotated as illustrated in FIG. 6C. Since the above-described driven rotation method is the same as a driving method when the pressing force is set to be the standard force, the driving configuration is simple and inexpensive.

Immediately after the fixing belt 310 is driven to rotate, the controller 500 starts turning on the heater 340 in step 4, and the heater 340 starts generating heat. To reduce the rotational torque of the pressure roller 320, the time until the start of turning on the heater 340 is preferably as short as possible. At this time, the controller 500 sets the power supplied to the heater 340 to be a small power that is smaller than a standard power that is a power during printing, and the heater 340 generates less heat (see a graph of the heater power in FIG. 7).

A width of the fixing nip SN when the heater 340 generates less heat is narrower in the sheet conveyance direction than a width of the fixing nip SN when the controller 500 sets the pressing force switching mechanism 400, which presses the heater 340 against the pressure roller 320 in the fixing nip SN, to the standard force state as illustrated in FIG. 2E because the controller 500 sets the pressing force switching mechanism 400 to the reduced force state as illustrated in FIG. 2E. The above-described configuration prevents the fixing belt 310 from being rapidly heated. Additionally, the above-described configuration can improve thermal efficiency because the amount of heat transferring from the heater 340 to the pressure roller 320 via the fixing belt 310 in the reduced force state is smaller than in the standard force state.

Since the fixing nip SN in the reduced force state is narrower in the sheet conveyance direction than the fixing nip SN in the standard force state, the fixing nip SN overlaps a part of the heat generation pattern in the heater 340 and does not overlap the other part of the heat generation pattern.

Based on the above, the heat generation pattern may be configured as separate heat generation patterns, that is, a part of the heat generation pattern in the heater 340 overlapping the fixing nip SN and the other part of the heat generation pattern not overlapping the fixing nip SN, which can be separately supplied with power. The above-described configuration can save power because turning off the power supplied to the part of the heat generation pattern not overlapping the fixing nip SN in the reduced force state can reduce the power supplied to the heater 340.

The controller 500 determines whether the temperature of the heater 340 has become equal to or higher than the predetermined temperature T1 when the heater 340 generates less heat in step S5. When the temperature is lower than the predetermined temperature T1 (No in step S5), the controller 500 maintains the power supplied to the heater 340 to be smaller than the power during printing, and the heater 340 continues to generate less heat in step S3 and step S4.

When the temperature of the heater 340 becomes equal to or higher than the predetermined temperature T1 (Yes in step S5), the controller 500 controls the pressing force switching mechanism 400 in step S6 to switch the pressing force from the reduced force to the standard force as illustrated in FIG. 2E. When the pressing force switching mechanism 400 switches the pressing force from the reduced force to the standard force, the fixing belt 310 and the heater 340 approach the pressure roller 320 as illustrated in FIG. 6D.

The controller 500 controls the pressing force switching mechanism 400 to maintain the pressing force to be the standard force and, in step S7, controls the motor M1 to rotate the pressure roller 320. The controller 500 may continue the rotation of the pressure roller 320 since the start of the rotation in step S3, or temporarily stop the rotation of the pressure roller 320 after the temperature of the heater 340 becomes equal to or higher than the predetermined temperature T1 (Yes in step S5) and before the controller 500 controls the pressing force switching mechanism 400 in step S6 to switch the pressing force from the reduced force to the standard force.

In step S8, the controller 500 controls the AC control board 510 so that the power supplied to the heater 340 increases to the standard power for printing while the pressure roller 320 rotates under the standard force state. In step 9, the controller 500 determines whether the detected temperature of the heater 340 is equal to or higher than the predetermined temperature T2. When the detected temperature of the heater 340 is lower than the predetermined temperature T2, the controller repeats step S7 and step S8 until the detected temperature reaches the predetermined temperature T2. The predetermined temperature T2 is a target temperature of a heating operation before starting printing, that is, the warm-up operation, and is about 150° C. to 200° C.

When the detected temperature of the heater 340 becomes equal to or higher than the predetermined temperature T2 (Yes in step S9), the controller 500 controls the AC control board 510 so that the power supply 520 stops supplying power to the heater 340 in step S10 and, after stopping supplying the power to the heater 340, controls the motor M1 to stop the rotation of the pressure roller 320 in step S11. Stopping the power supply to the heater 340 before stopping the rotation of the pressure roller 320 prevents the pressure roller 320 from overheating.

When the temperature of the heater 340 is much higher than the predetermined temperature T2, the controller 500 continues the rotation of the pressure roller 320 until the temperature of the heater 340 drops to near the predetermined temperature T2 and stops the rotation of the pressure roller 320 after the temperature of the heater 340 drops to near the predetermined temperature T2. This is because stopping the rotation of the pressure roller 320 when the temperature of the heater 340 is much higher than the predetermined temperature T2 may cause thermal deformation of the fixing belt 310.

Stopping the rotation of the pressure roller 320 is the last operation before the image forming apparatus starts printing, and the image forming apparatus waits a signal of print job start and, after receiving the signal, starts the print job. Maintaining the standard force mode in the pressing force switching mechanism 400 as illustrated in FIG. 2E until the image forming apparatus starts printing can shorten a time lag between a time when the image forming apparatus receives the signal and a time when the image forming apparatus starts the print job.

When at least a predetermined period of time has passed before the image forming apparatus starts the print job, the controller 500 may control the pressing force switching mechanism 400 to temporarily return to the reduced force state as illustrated in FIG. 2D. The reduced force state reduces a width of the fixing nip SN and decreases the amount of heat transferring to the pressure roller 320.

As described above, the heating device in the embodiment of the present disclosure has a smaller rotational torque than conventional heating devices because, after the temperature of the heater 340 reaches the predetermined temperature T1, the controller 500 controls the pressing force switching mechanism 400 to set the standard force state and the motor M1 to rotate the pressure roller 320. Conventional heating devices have a disadvantage in that the lubricant in the inner nip having high viscosity under low temperature causes a large starting torque of the pressure roller 320 because the pressure roller 320 separates from the heater 340 before the warm-up operations and, in the warm-up operations, rapidly contacts the heater 340 and rotates at the same time when the heater starts to generate heat.

Note that the pressing force switching mechanism 400 switches the pressing force of the heater 340 between two levels, large or small. Alternatively, the pressing force switching mechanism 400 may be configured to switch the pressing force of the heater 340 between three or more steps, or steplessly and continuously. When the pressing force switching mechanism 400 switches the pressing force of the heater 340 between three or more steps, or steplessly and continuously, the power supplied to the heater 340 may be switched between the three or more steps, or steplessly and continuously. At this time, the thermistor TH in the heater 340 may be designed to detect temperatures corresponding to the three or more steps, or a range of continuous pressing forces so that the controller 500 can determine suitable pressing forces for detected temperatures. The above-described configuration can further reduce the rotational torque of the pressure roller 320. The heat generation pattern 360 may be a plurality of planar heat generation patterns arranged in the longitudinal direction of the base 350 and coupled in parallel in addition to the heat generation pattern 360 formed in two lines parallel to the longitudinal direction of the base 350 and connected in series.

The present disclosure is not limited to the embodiments described above, and various alterations can be made in the scope of the technical idea described in the scope of the claims. For example, the heating devices according to the embodiments of the present disclosure are applicable to not only the fixing device of the image forming apparatus but also to a dryer for sheets installed in an inkjet printer or other drying devices for sheets.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A heating device comprising:
a sleeve-shaped flexible fixing rotator;
a heater configured to contact an inner surface of the fixing rotator;
a pressure rotator pressed against the heater via the fixing rotator to form a nip between the fixing rotator and the pressure rotator, through which a medium to be heated by the heater is conveyed;
a thermometer configured to detect a temperature of the heater; and
a pressing force switching mechanism configured to switch a pressing force between the heater and the pressure rotator in at least two stages:
a standard force when the temperature of the heater detected by the thermometer increases and reaches a predetermined temperature and before the medium to be heated passes through the nip, and
a reduced force smaller than the standard force when the temperature of the heater detected by the thermometer is lower than the predetermined temperature.

2. The heating device according to claim 1,
wherein the heater includes a heat generation pattern including a resistance heat generator, and a part of the heat generation pattern overlaps the nip when the pressing force switching mechanism sets the pressing force to the reduced force.

3. The heating device according to claim 2,
wherein the part of the heat generation pattern overlapping the nip is configured to receive power separately from another part of the heat generation pattern not overlapping the nip.

4. The heating device according to claim 1, further comprising lubricant between the fixing rotator and the heater,
wherein the predetermined temperature is equal to or higher than a softening point of the lubricant.

5. The heating device according to claim 1,
wherein the fixing rotator is driven to rotate by rotation of the pressure rotator when the fixing rotator presses against the pressure rotator with the standard force.

6. The heating device according to claim 1, further comprising a power supply configured to supply power to the heater,
wherein, when the pressing force switching mechanism sets the pressing force to the reduced force, the power supply supplies smaller power than power supplied when the pressing force switching mechanism sets the pressing force to the standard force.

7. A fixing device comprising the heating device according to claim 1.

8. An image forming apparatus comprising the fixing device according to claim 7.
